(19) United States
(12) Patent Application Publication
(10) Pub. No.: US 2020/0332926 A1
(43) Pub. Date: Oct. 22, 2020

(54) COATED BRAIDED HOSE ASSEMBLY AND METHOD OF MAKING SAME

(71) Applicant: Norman S. MARTUCCI, Clarkston, MI (US)

(72) Inventor: Norman S. MARTUCCI, Clarkston, MI (US)

(21) Appl. No.: 16/759,425

(22) PCT Filed: Oct. 24, 2018
(86) PCT No.: PCT/US18/57230

§ 371 Date: Apr. 27, 2020

Related U.S. Application Data
(60) Provisional application No. 62/576,795, filed on Oct. 25, 2017.

(51) Int. Cl. F16L 11/08; F16L 33/22

(52) U.S. Cl. CPC F16L 11/085; F16L 33/225

(57) ABSTRACT

A hose assembly including a tubular member having an inner liner that is integrated into gaps of a support layer. A method of making a hose assembly, by extruding a tubular member of an inner liner of a polymer, forming a support layer about the exterior of the inner liner, and heating at least a portion of an outside diameter of the hose assembly such that only an interface of the outer diameter of the inner liner and the support layer melts, gently expanding the inner liner into the gaps of the support layer such that the inner liner fills the gaps and the support layer is adhered to the inner liner. A method of making a hose assembly, by passively wicking the inner liner into the gaps of the support layer.

### BACKGROUND OF THE INVENTION

### 1. Technical Field

The present invention relates to a hose assembly. More specifically, the present invention relates to a hose assembly for conducting fluid therethrough, preferably in automotive applications such as conducting fuel, brake fluids, and the like.

### 2. Background Art

Hose assemblies used to carry fuels are well known in the art. The hose should preferably be strong and resistant to heat and chemical degradation. These hoses are subject chemical breakdown by the various fluids which flow through them. Further, these hoses are typically routed through the engine compartment of the vehicle to deliver fuel to the engines. These engines are hot and thus, the hoses used to carry fuel are subject to breakdown from the heat.

TEFLON® (polytetrafluoroethylene, Dupont) hoses provide the necessary physical properties for carrying fuels. A major problem with these types of hoses is that when used alone, i.e., only a TEFLON® liner or conduit, they tend to get bent during installation and they kink. This kink or deformation remains permanent and provides constant resistance to fluid flow through the hose. To solve this problem, one known hose assembly includes an inner TEFLON® tubular member. The inner tubular member is surrounded by a tightly wound metallic braid. The metallic braid allows the TEFLON® inner tubular member to bend to a certain degree without kinking. However, if bent past a certain point the metallic braid aids in the kinking of the inner tubular member. This assembly has three major disadvantages. First, the metallic braid tends to abrade the exterior of the inner tubular member. This causes leaks from the inner tubular member. The second problem is that the exterior metallic braided casing is thermally and electrically conductive. More important is that the metallic braid will retain heat and transfer the heat to the fuel moving through the inner tubular member causing fuel system problems. Finally, when used in an automotive environment, the metallic braid transmits noise during operation of the vehicle which is undesirable.

U.S. Pat. No. 5,613,524 to Martucci discloses a hose assembly for carrying fuels. The assembly includes an inner fluorocarbon polymer liner. In one embodiment, glass fiber is braided about the inner liner. An outer layer of a fluorocarbon foam is disposed over the glass fiber braided layer.

U.S. Pat. No. 4,111,237 to Mutzner, et al. discloses a hose assembly that includes a polychloroprene inner liner. A glass fiber is then braided about the exterior of the inner liner. A rubber layer is then wrapped over the braided layer. A second braided layer of nylon is then placed about the rubber layer. Finally, a cover of polychloroprene is then extruded about the second braided layer.

U.S. Pat. No. 3,547,162 to Schuerer discloses a plastic pipe assembly that includes an inner liner of a synthetic plastic made from cross linked olefinic polymers. A fiber braided layer is disposed over the inner liner. Finally, a foamed layer of synthetic plastic is disposed about the synthetic fiber reinforcement. By utilizing cross linked olefinic polymers, the system is deficient in that it cannot be used to carry vehicle fuels, as such fuels would degrade the inner liner. Further, this assembly requires a very thick outer casing to provide the necessary strength.

U.S. Pat. No. 5,142,782 to Martucci discloses a method of making a lightweight hose assembly including a step of extruding the inner liner. A nonmetallic material is then braided about the exterior of the liner. The inner liner and braided layer are then passed through a reservoir containing a solution of the fluorocarbon polymer. The solvent is then removed, leaving a fluorocarbon polymer coating dispersed throughout the braided layer. The braided layer, preferably fiberglass, prevents kinking of the inner tube. This is critical because a kink on the inner surface of the tube can cause static electricity to occur, eventually igniting the gasoline contained therein. But a problem existed on how to adhere the braid to the inner tube. The patented solution was to adhere the braid to the inner tube with a Teflon emulsion coating applied to the outer surface of the braid. The emulsion penetrated the interstices of the braid to adhere to the outer surface of the inner tube. This was a complex and expensive process requiring vertical lines for effectively forming the inner tube from the paste extrusion Teflon and additional dipping, heating, and drying steps for applying the emulsion. The process also used expensive paste extrusion Teflon.

There remains a need for braided hose assemblies, especially those that can be manufactured at lower temperatures, in fewer steps, and with less expensive Teflon than the prior art.

### SUMMARY OF THE INVENTION

The present invention provides for a hose assembly including a tubular member having an inner liner that is integrated into gaps of a support layer.

The present invention also provides for a method of making a hose assembly, by extruding a tubular member of an inner liner of a polymer, forming a support layer about the exterior of the inner liner, and heating at least a portion of an outside surface of the hose assembly such that only an interface of the outer surface or diameter of the inner liner melts, gently expanding the inner liner into the gaps or interstices of the support layer such that the inner liner fills the gaps and, after cooling, the support layer is adhered to the outer surface of inner liner.

The present invention further provides for a method of making a hose assembly by extruding a tubular member of an inner liner of a polymer, forming a support layer about the exterior outer surface of the inner liner, and heating at least a portion of an outside surface or diameter of the inner liner such that only an interface of the outer surface or diameter of the inner liner melts, passively wicking the melted outer surface or diameter of the inner liner into gaps of the support layer such that the inner liner fills the gaps and upon cooling, the support layer is adhered to the inner liner, providing a less costly process than the prior art.

### DESCRIPTION OF THE DRAWINGS

Other advantages of the present invention are readily appreciated as the same becomes better understood by reference to the following detailed description when considered in connection with the accompanying drawings wherein:

FIG. 1 is a perspective view of the preferred embodiment of the instant invention;

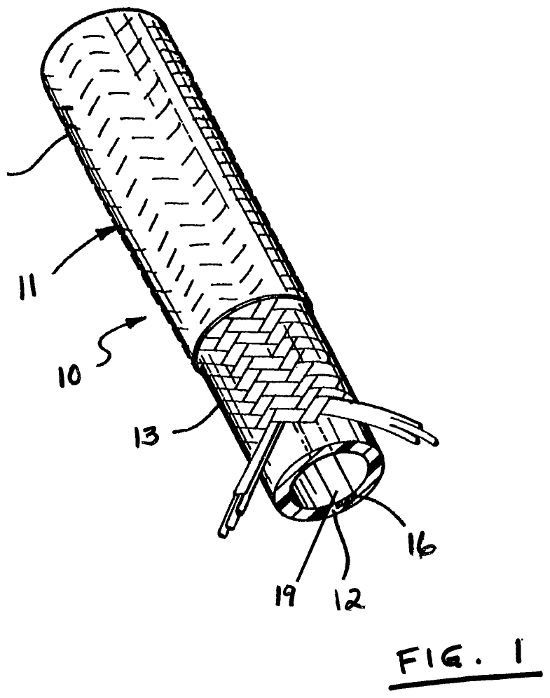

FIG. 2 is a side view partially broken away of the preferred embodiment of the instant invention including a coupling member;

FIG. 3 is a side view partially broken away of the preferred embodiment of the instant invention including an alternative coupling member;

FIG. 4 is an enlarged sectional view of the hose assembly;

FIG. 5 is an enlarged partial view of another preferred embodiment of the instant invention; and

FIG. 6 is an enlarged sectional view of the hose assembly with conductive material dispersed throughout the inner liner.

### DETAILED DESCRIPTION OF THE INVENTION

The present invention provides for hose assemblies and methods of making hose assemblies at lower temperatures than prior art processes.

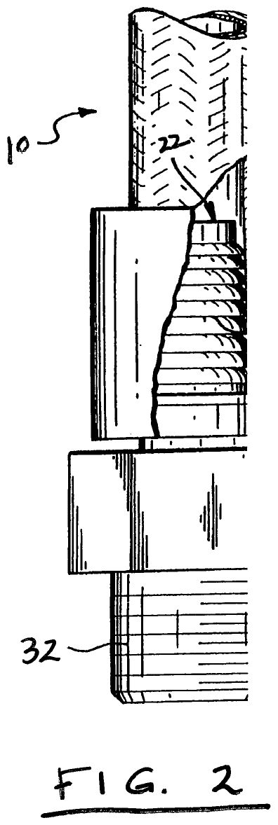

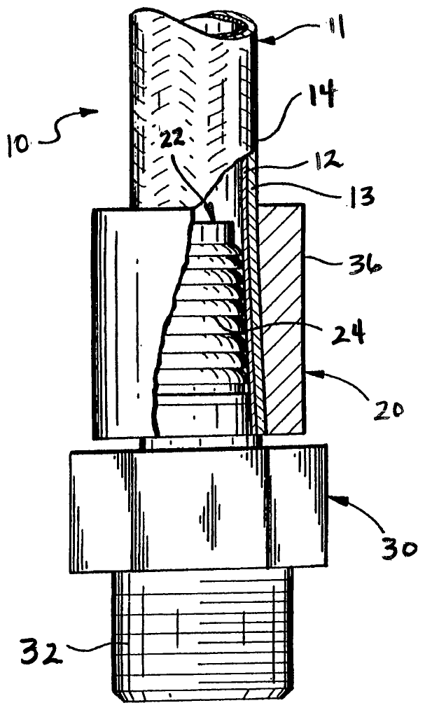

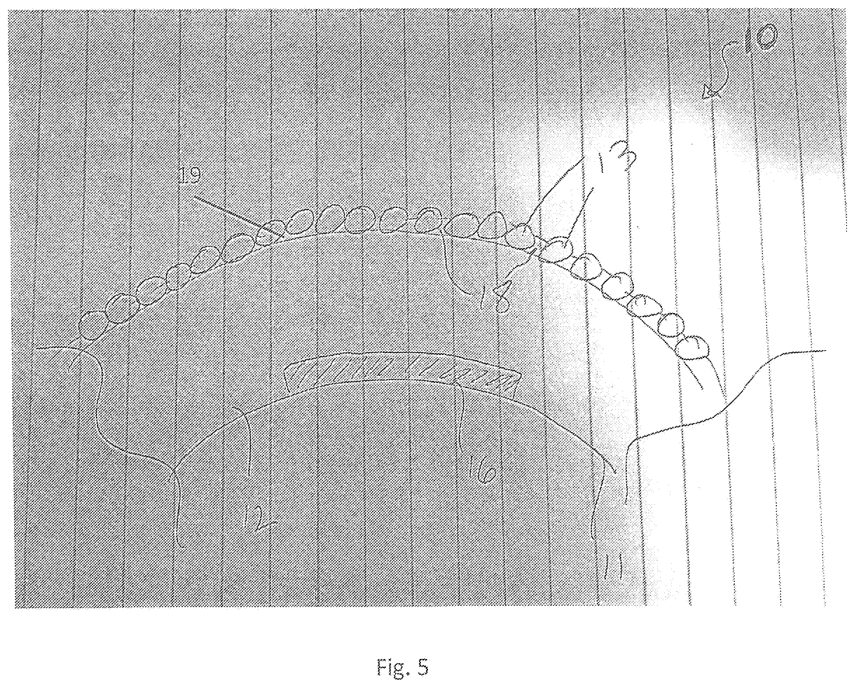

The hose assembly is generally shown at 10 in the FIGURES. The hose assembly 10 includes a tubular member, generally indicated at 11, having an inner liner 12 that is integrated into gaps 18 of a support layer 13, best shown in FIG. 5. The assembly further includes a coupling mechanism, generally indicated at 20 (as best viewed in FIGS. 2 and 3), for connecting the ends of the tubular member 11 to fittings for conducting fluid therethrough.

The tubular member 11 includes an inner organic polymeric liner 12. The inner liner 12 is preferably extruded and has a wall thickness of between 0.001 and 0.120 inches. The inner liner 12 is preferably made of a melt extrudable fluorocarbon polymer. For example, fluorinated ethylene propylene (FEP) and perfluoroalkoxy (PFA) are melt-processable by conventional thermoplastic processing methods, including injection, transfer, blow, and compression molding and by extrusion. FEP in particular is chemically inert and has a low resistance, a low coefficient of friction, exceptional dielectric properties, heat resistance, retention of properties after service at 400° F. (240° C.) with useful properties at −454° F. (−270° C.), Most preferably, the inner liner 12 is made of the polymer of (FEP), which is able to be melt extruded. The inner liner 12 can optionally be made of any other melt extrudable polymer that is able to be extruded, or any other suitable polymer, including, but not limited to, nylon, paste extrusion fluorocarbon polymer, polyethylene, polypropylene, polystyrene, polyvinyl chloride, neoprene, or polyacrylonitrile, silicone. The fluorocarbon polymer FEP is sold under common tradenames including Daikin NEOFLON®, Dupont TEFLON®, and Hoechst HOSTAFLON®.

The inner liner 12 is impervious to fluid flow through the wall. Since the inner liner 12 is preferably made of a melt extrudable fluorocarbon polymer material, it is resistant to both heat and chemical degradation. This allows a variety of fluids, particularly vehicle fuels, to pass through the interior of the liner 12 without corroding the liner 12.

The assembly 10 further includes a reinforcing helical, braided or woven support layer 13 about the exterior of the inner liner 12. The helical, braided or woven support layer 13 can comprise any nonmetallic material disposed in interleaving fashion or wrapped tightly about the inner liner 12. Preferably the material to be used for the support layer 13 is glass fiber. Glass fibers provide the necessary strength. Further, glass fibers are heat resistant which is important for use in heated environments and for making the assembly as will be described subsequently.

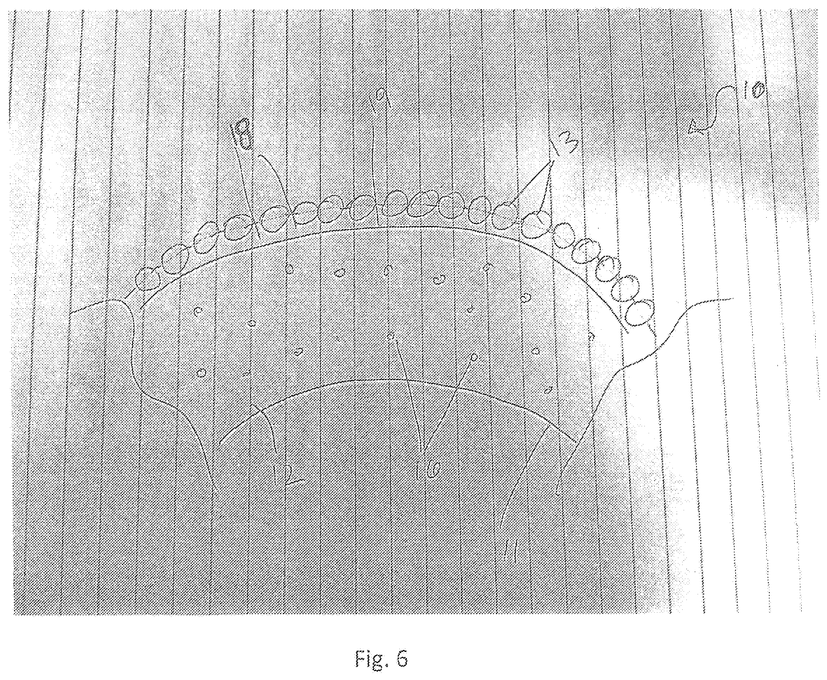

The helical, braided, or woven fibers may be tightly wound or they may be loosely wound about the inner liner 12 having wide gaps or interstices 18 between adjacent fibers. In the preferred embodiment shown in FIGS. 5 and 6, the glass fibers are tightly woven such that the gaps 18 or spaces between adjacent fibers is minimal. During the manufacturing of the hose assembly 10, the inner liner 12 is actively expanded or forced into the gaps 18 and/or passively wicked into the gaps such that the gaps 18 are filled with the polymer and this adheres the support layer 13 to the inner liner 12. This is the complete assembly not requiring an outer coating layer as the support layer 13 is effectively adhered to the inner liner 12 without any additional materials, steps, or processes thereby effectively and significantly lowering the cost of the finished product. Also, only a portion of an outer surface 19 (i.e. an outer diameter 19) of the inner liner 12 needs to be melted (the entire outer surface 19 does not need to be melted, although it can be) for the support layer 13 to be applied (any material to support against pressure or vacuum), and the support layer 13 adheres to melted outer surface 19. Preferably, the outer surface 19 enters gaps 18. The goal is that the support layer 13 connected to tubular member 11 resists the tubular member 11 from kinking. In fuel lines, kinks in tubes cause static electricity build up and potential fire.

Braid tension, braid angle, and yarn twist can be tuned/adjusted to control braid growth and bond. That is, for any specific application of the present technology, these properties can be adjusted to handle different application pressures, such as use in a diesel engine versus use in an automobile engine fuel line. Along these lines, the yarn can be braided or helical (single or multiple helixes) to hold a given application pressure or vacuum.

The support layer 13 adds to the strength of the inner liner 12. Particularly, by using a support layer 13, the working pressure of the inner liner 12 is increased, allowing a higher pressure fluid to flow through the inner liner 12. Further, the support layer 13 adds to the tensile strength of the hose assembly 10. When coupling members 20 are disposed on the ends of the tubular member 11, as will be described subsequently, the support layer 13 increases the tensile strength of the hose assembly 10 sufficiently to fixedly connect any type of coupling member 20 to the tubular member 11. Finally, the support layer 13 adds to the hoop strength of the inner liner 12.

An outer surface 19 of the inner liner 12 can be heated by conventional means of heat sources, such as ovens known in the art, infrared (IR), hot air, or other means. With IR, heat can be controlled to only heat the outer surface 19, saving on energy cost and lowering manufacturing cost by obviating the need for dipping in a dispersion and further heating and cooling steps. Heating the support layer 13 by any of these methods can heat the outer surface 19 of the inner liner 12. The outer surface 19 of the inner liner 12 and also the braid can be darkened or blackened by means well known in the art, such as the application of carbon black, to preferentially absorb more applied heat at the outer diameter than the remainder of the inner liner 12. Thereby the outer surface 19 of the inner liner 12 is preferentially heated and melted, again saving energy costs in the manufacturing process, instead of an outer surface wicking inwards as in the prior art. For example, if FEP is used, the melt temperature of FEP is approximately 500 degrees F. Temperatures for grades of polymer will be certified by the supplier/manufacturer for degradation, melt, gel, and crystallization and processing.

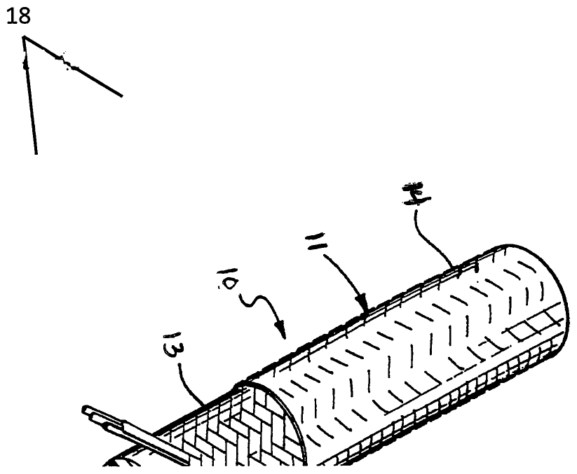

The assembly 10 can further optionally include an organic polymeric dispersion or coating 14 in the support layer 13 thereby providing an additional outer protective polymer coating 14 over the support layer 13 and protection from UV should the braid be made from kevlar. Specifically, an organic polymeric material can be dispersed about the support layer 13 and is located from the outer periphery of the support layer 13 radially inwardly toward the inner liner 12 (as best viewed in FIG. 4). The organic polymeric material is deposited so as to penetrate into the gaps or interstices of the support layer 13 as well as coat the support layer 13. The coating 14 preferably comprises a fluorocarbon polymer. Specifically, the coating 14 comprises the polymer of tetrafluoroethylene (PTFE), the polymer of fluorinated ethylene propylene (FEP), the polymer of perfluoroalkoxy resin (PFA), or the polymer of ethylene-tetrafluoroethylene (ETFE).

The coating 14 can cover or coat the glass fibers of the support layer 13. That is, the coating 14 covers the fibers of the support layer 13 from the outer periphery radially inwardly to the portions of the outer surface 19 of the inner liner 12 that penetrate into the gaps or interstices of the support layer 13 from the inside thereof. The coating, therefore, does not extend radially outwardly from the outer periphery of the support layer 13. After the material has been coated, each fiber is discernible. In effect, what results is a coating 14 having the support layer 13 therein.

The outer coating 14 is preferably formed by first braiding or wrapping the support layer 13 about the exterior of the inner liner 12. The organic polymeric material is then dispersed into the support layer 13 from the outer periphery of the support layer 13 radially inwardly toward the portion of inner liner that has penetrated into the gaps of the support layer 13. Preferably, the organic polymeric material is a fluorocarbon polymer in a dispersion. In other words, the coating 14, as applied, comprises the fluorocarbon polymer and at least one carrying fluid. The preferable fluid is water. It will be appreciated that any suitable fluid may be used. The fluorocarbon polymer solution coats or is dispersed throughout the entire support layer 13. Specifically, the fluorocarbon polymer dispersion effectively coats each of the glass fibers from the outer periphery radially inwardly to the portion of the inner liner 12 that has penetrated the gaps or interstices. That is, the glass fibers are coated such that any gap between adjacent fibers will be filled with the polymer dispersion. Also, the outer periphery of each fiber is completely coated. The carrying fluid is then removed from the dispersion by drying. This leaves a fluorocarbon polymer material dispersed throughout support layer 13. Alternatively, the support layer 13 materials such as yarn can be predipped or precoated with the coating materials or dye can be applied to allow for color coding of the final product. Starch can be used to coat the yarn as starch is a lubricant that can reduce corrosion caused by the yarn rubbing up against other proximate structures.

The coating 14 can include carbon black or be a black emulsion such that the appearance of the support layer 13 after application is black. The coating 14 can be applied by a dipping process or a spraying process.

As previously stated, both the inner liner 12 and coating 14 are preferably fluorocarbon polymers. It is, however, not necessary that both the inner liner 12 and coating 14 be of the same fluorocarbon polymer, although they can be. For example, the inner liner 12 can be made of FEP while the coating 14 can made of PTFE. Any combination of the fluorocarbon polymers can be utilized for the inner liner 12 and coating 14, as long as the fluorocarbon polymer of the inner liner 12 is capable of being extruded at 400 degrees F.

The coating 14 in conjunction with the support layer 13 allows the inner liner 12 to be bent without kinking. That is, the coating 14 dispersed throughout the support layer 13 provides strength to the inner liner 12 upon bending. This is commonly referred to as hoop strength. Thus, by using a polymeric coating 14 dispersed throughout the support layer, a trim profile assembly is produced which results in the hoop strength of the tubular member 11 being increased so that the tubular member 11 can be bent without kinking the inner liner 12. Further, the outer coating 14 adds to the working pressure of the hose. That is, the coating 14 provides strength and allows the inner liner 12 to accommodate a fluid under pressure. Also, the coating 14 hinders abrasion of the tubular member. Said another way, the coating 14 aids in abrasion resistance of the tubular member 11. That is, because the coating is continuous about the outer periphery of the support layer 13, the support layer 13 is not subject to abrasion. The coating 14 resists abrasion.

The assembly 10 further includes a coupling mechanism generally indicated at 20. The coupling mechanism 20 is for connecting the assembly 10 to a fitting (not shown). The fitting is adapted to cooperate with the coupling mechanism 20. Specifically, the coupling mechanism 20 comprises a coupling assembly 20. The coupling assembly 20 includes an insert portion, generally indicated at 22 for inserting into and engaging the interior inner liner 12. The insert portion 22 may have a plurality of barbs 24 for engaging the interior of the inner liner 12 (as best viewed in FIG. 2). Alternatively, the insert portion may have a pair of annular ridges 26, and a smooth portion 28 therebetween (as best viewed in FIG. 3). The coupling assembly 20 further includes an engaging portion generally indicated at 30 extending longitudinally from the insert portion. The engaging portion is for engaging a fitting (not shown) adapted to cooperate therewith. The engaging portion 30 may comprise a male threaded member 32 (FIG. 2) or a female threaded member 34 (FIG. 3). The engaging portion 30 may also comprise any configuration adapted to cooperate with a member to which it will be fixed. For example, the engaging portion 30 may comprise a socket to receive a mating ball joint. Finally, the coupling assembly 20 includes a locking collar 36. The locking collar 36 is disposed about the exterior of the outer coating 14 and is slid over the insert portion 22 of the coupling assembly 20. In this manner, the inner liner 12 is forced into tight frictional engagement with the insert portion 22 to prevent relative axial movement between the inner liner 12 and insert portion 22. The coupling assembly 20 can be of any other well known type. For example, the coupling assembly 20 may be of an organic polymeric material and may be molded about the tubular member 11 for a mechanical connection or fusion bond.

As fluid flows through the inner liner 12, electrical charges tend to build throughout the length of the inner liner 12. In order to prevent these electrical charges from accumulating, the inner liner 12 can have an integral longitudinal conductive means coextensive with the length of the inner liner 12 for conducting an electrical charge through the liner. Preferably, the inner liner 12 has a conductive material 16 (such as in the form of a strip) of carbon black. This carbon black is electrically conductive and will dissipate any electrical charges built up by the fluid. Alternatively, the whole inner liner 12 can comprise the conductive material 16 dispersed therein (such as in FIG. 6). This is done by using carbon black about the entire inner liner 12. The support layer 13 and coating 14 are preferably electrically non-conductive. This is important in that electrical changes applied to the exterior of the outer coating 14 will not be conducted throughout the length of the tubular member 11 or to the fluid passing through the interior of the inner liner 12. It will be appreciated that other conductive material may be used to form the conductive material 16.

The preferred method for making a hose assembly 10 as shown is as follows. An inner organic polymeric tubular liner 12 is provided. Specifically, the inner liner 12 of a polymer (preferably fluorocarbon) is melt extruded and has a melt temperature of about 500 degrees F. A nonmetallic or wound material (preferably glass fiber) is then braided or wound about the exterior of the inner liner 12 to form a support layer 13. A slight internal pressure is applied and heat at a temperature of about 500 degrees F. is applied to the outside of the assembly 10 such that only at least a portion of an outer surface 19 between the inner liner 12 and support layer 13 melts. The internal pressure applied gently expands the inner liner 12 into the gaps 18 of the support layer 13 such that the melted outer diameter of the inner liner 12 either simply contacts and adheres to the support layer 13 and/or fills the gaps 18 (being dispersed into the support layer 13 radially outward), and the support layer 13 is adhered to the inner liner 12. Alternatively or in addition thereto, the melted outer surface 19 or periphery will passively wick into the gaps 18.

An organic polymeric material dispersion 14 can optionally be dispersed throughout the support layer 13 from the outer periphery radially inwardly toward the portions of the inner liner 12 that have penetrated the gaps 18 of the support layer 13. Specifically, the inner liner 12 and support layer 13 are passed through a reservoir containing a dispersion of an organic polymeric material and at least one carrying fluid. Alternatively, the dispersion may be sprayed onto the support layer 13. Preferably, the dispersion is an aqueous dispersion of a fluorocarbon polymer. Because the dispersion is preferably aqueous, the carrying fluid used is preferably water. The dispersion is disposed throughout the entire support layer 13. The carrying fluid, preferably water, is then removed from the solution. Specifically, the assembly 10 is sent to a dryer, a preheat oven which is preferably below the boiling temperature of the fluid (water). By utilizing an oven below the boiling temperature of the carrying fluid, a bubbling effect is avoided in the final product. The temperature can be above the boiling temperature, however, the assembly (10) may contain many air bubbles in the outer coating 14 if higher temperatures are used. The carrying fluid (water) is removed to leave a coating 14 of an organic polymeric material dispersed throughout the support material 13. The assembly 10 is then sintered at a suitable temperature to cure the organic polymeric coating 14. Because glass fibers are used for the support layer 13, the support layer 13 is unaffected by the heat required to sinter the assembly 10.

Finally, a coupling member 20 can be secured on one or both ends of the tubular member 11 to secure the assembly 10 to a fitting (not shown) for conducting fluid through the inner liner 12.

Throughout this application, various publications, including United States patents, are referenced by author and year and patents by number. Full citations for the publications are listed below. The disclosures of these publications and patents in their entireties are hereby incorporated by reference into this application in order to more fully describe the state of the art to which this invention pertains.

The invention has been described in an illustrative manner, and it is to be understood that the terminology, which has been used is intended to be in the nature of words of description rather than of limitation.

Obviously, many modifications and variations of the present invention are possible in light of the above teachings. It is, therefore, to be understood that within the scope of the appended claims, the invention can be practiced otherwise than as specifically described.

What is claimed is:

1. A hose assembly comprising a tubular member having an inner liner that is integrated into gaps of a support layer.

2. The hose assembly of claim 1, wherein the hose assembly resists kinking.

3. The hose assembly of claim 1, wherein said inner liner has a wall thickness of between 0.001 and 0.120 inches.

4. The hose assembly of claim 1, wherein said inner liner is made of a melt extrudable fluorocarbon polymer.

5. The hose assembly of claim 4, wherein said melt extrudable fluorocarbon polymer is chosen from the group consisting of fluorinated ethylene propylene (FEP) and perfluoroalkoxy (PFA).

6. The hose assembly of claim 1, wherein said inner liner is impervious to fluid flow through its wall.

7. The hose assembly of claim 1, wherein said support layer is chosen from the group consisting of a helical support layer, a braided support layer, and a woven support layer.

8. The hose assembly of claim 1, wherein said support layer is made of glass fiber.

9. The hose assembly of claim 1, wherein fibers of said support layer are woven in a manner chosen from the group consisting of tightly wound and loosely wound.

10. The hose assembly of claim 1, wherein a working pressure of said inner liner is increased through the addition of said support layer.

11. The hose assembly of claim 1, wherein said support layer increases tensile strength of said hose assembly.

12. The hose assembly of claim 1, wherein an outer surface of said inner liner is blackened.

13. The hose assembly of claim 1, further including an outer protective polymer coating over said support layer that penetrates gaps of said support layer radially inwardly towards said inner liner.

14. The hose assembly of claim 13, wherein said outer protective polymer coating includes a fluorocarbon polymer chosen from the group consisting of the polymer of tetrafluoroethylene (PTFE), the polymer of fluorinated ethylene propylene (FEP), the polymer of perfluoroalkoxy resin (PFA), and the polymer of ethylene-tetrafluoroethylene (ETFE) and a carrying fluid.

15. The hose assembly of claim 13, wherein said outer protective polymer coating provides hoop strength to said tubular member such that said tubular member can be bent without kinking said inner liner.

16. The hose assembly of claim 13, wherein said outer protective polymer coating resists abrasion.

17. The hose assembly of claim 1, wherein said support layer is precoated with an outer protective polymer coating.

18. The hose assembly of claim 1, wherein said inner liner further includes a conductive material coextensive with a length of said inner liner.

19. The hose assembly of claim 18, wherein said conductive material is dispersed within said inner liner.

20. The hose assembly of claim 1, further including a coupling mechanism for connecting ends of said tubular member to fittings.

21. The hose assembly of claim 20, wherein said coupling mechanism includes a coupling assembly having an insert portion for engaging said inner liner, an engaging portion extending longitundinally from said insert portion for engaging a fitting, and a locking collar disposed about an exterior of said outer protective polymer coating for sliding over said insert portion.

22. The hose assembly of claim 21, wherein said coupling mechanism prevents relative axial movement between said inner liner and said insert portion.

23. A method of making a hose assembly, including the steps of:
extruding a tubular member of an inner liner of a polymer;
forming a support layer about the exterior of the inner liner; and
heating at least a portion of an outside surface of the hose assembly such that only an interface of the outer surface of the inner liner and the support layer melts, gently expanding the inner liner into the gaps of the support layer such that the inner liner fills the gaps and the support layer is adhered to the inner liner.

24. The method of claim 23, wherein said heating step is further defined as applying a heat source chosen from the group consisting of an oven, infrared, and hot air to a temperature of about 500 degrees F.

25. The method of claim 23, wherein said gently expanding step further includes creating a slight internal pressure.

26. The method of claim 23, wherein the outer surface of the inner liner is blackened to preferentially heat and melt the outer surface.

27. The method of claim 23, wherein said forming step is further defined as braiding or wrapping the support layer about the exterior of the inner liner.

28. The method of claim 23, further including the step of adding an outer protective polymer coating over the support layer.

29. The method of claim 28, wherein said step of adding an outer protective polymer coating over the support layer is further defined a step chosen from the group consisting of passing the inner liner and support layer through a reservoir containing a dispersion of an organic polymeric material and at least one carrying fluid, and spraying a dispersion of an organic polymeric material and at least one carrying fluid onto the support layer.

30. The method of claim 28, wherein said step of adding an outer protective polymer coating over the support layer is further defined as dispersing the outer protective polymer coating from an outer periphery of the support layer radially inwardly toward a portion of inner liner that has penetrated into gaps of the support layer.

31. The method of claim 31, wherein gaps between adjacent fibers of the support layer are filled with the outer protective polymer coating.

32. The method of claim 28, further including the step of removing carrying fluid of the outer protective polymer coating by drying.

33. The method of claim 28, further including the step of sintering and curing the outer protective polymer coating.

34. The method of claim 28, further including the step of securing at least one coupling member to an end of the tubular member and securing the hose assembly to a fitting.

35. A method of making a hose assembly, including the steps of:
extruding a tubular member of an inner liner of a polymer;
forming a support layer about the exterior of the inner liner; and
heating at least a portion of an outside surface of the hose assembly such that only an interface of the outer surface of the inner liner and the support layer melts, passively wicking the inner liner into the gaps of the support layer such that the inner liner fills the gaps and the support layer is adhered to the inner liner.
